(19) United States
(12) Patent Application Publication
(10) Pub. No.: US 2004/0268021 A1
(43) Pub. Date: Dec. 30, 2004

(54) FLASH memory blank check

(75) Inventor: Peter T. Larsen, Citrus Heights, CA (US)

Correspondence Address: LeMoine Patent Services, c/o PortfolioIP, P.O. Box 52050, Minneapolis, MN, 55402, US

(73) Assignee: Intel Corporation

(21) Appl. No.: 10/602,320

(22) Filed: Jun. 24, 2003

(51) Int. Cl. G06F 12/00

(52) U.S. Cl. 711/103

(57) ABSTRACT

A FLASH memory device performs a blank check and sets a status bit to indicate blank or not blank.

### FIELD

The present invention relates generally to memory devices, and more specifically to blank checking of memory devices.

### BACKGROUND

FLASH memories are typically blank checked prior to programming. Blank checking of FLASH memories takes time.

### BRIEF DESCRIPTION OF THE DRAWINGS

FIG. 1 shows a block diagram of a memory device;

FIG. 2 shows a block diagram of a status register;

FIG. 3 shows a flowchart in accordance with various embodiments of the present invention;

FIGS. 4 and 5 show system diagrams in accordance with various embodiments of the present invention; and

FIG. 6 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

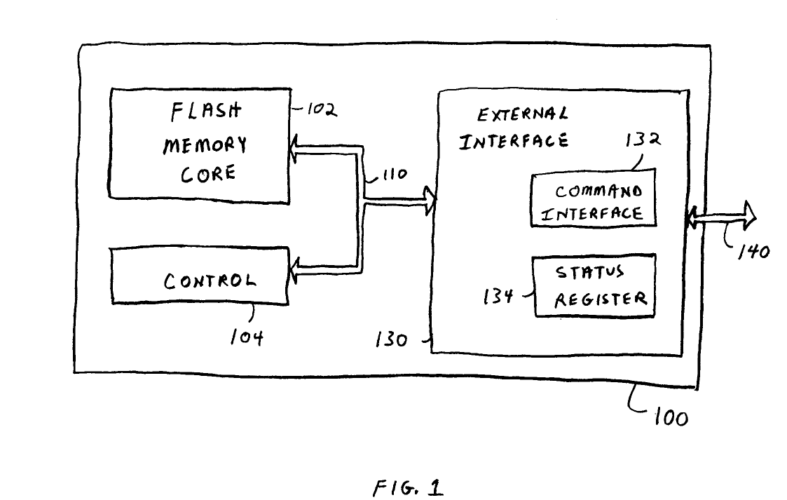

FIG. 1 shows a block diagram of a memory device. Memory device 100 includes FLASH memory core 102, control block 104 and external interface 130. FLASH memory core 102 may be a digital storage device that includes non-volatile memory. For example, FLASH memory core 102 may include floating gate electrically erasable programmable read only memory (EEPROM), but this is not a limitation of the present invention. FLASH memory core 102 may be arranged in blocks, or may be arranged as a single block. Blocks may be addressable separately, or in parallel. Any addressing scheme may be utilized without departing from the scope of the present invention.

In some embodiments, FLASH memory core 102 may be a NOR-type, and in other embodiments, FLASH memory core 102 may be a NAND-type. Memory cells in FLASH memory core 102 may store one data bit per cell, or memory cells may be multilevel cells (MLC) capable of storing more than one bit per cell. Any FLASH memory arrangement may be utilized within FLASH memory core 102 without departing from the scope of the present invention.

External interface 130 includes command interface 132 and status register 134. External interface 130 may also include other registers, memory-mapped or not, and may also include other circuitry to support communications between memory device 100 and other integrated circuits. For example, external interface may include circuitry in support of chip-enable signals, programming pins and voltages, and the like. Bus 140 provides a communications path between external interface 130 and devices external to memory device 100. Bus 140 may include an address bus, a data bus, conductors to carry control signals, or any other media for communications.

In some embodiments, command interface 132 includes a single register to which commands may be written via bus 140. In other embodiments, command interface 132 includes multiple registers to which commands may be written via bus 140. The invention is not limited with respect to the particular memory-mapped organization of command interface 132. Various commands can be issued to memory device 100 using command interface 132. For example, a blank check command may be issued to memory device 100 by interaction between an external device and command interface 132. Examples of this interaction are described in more detail with respect to later figures.

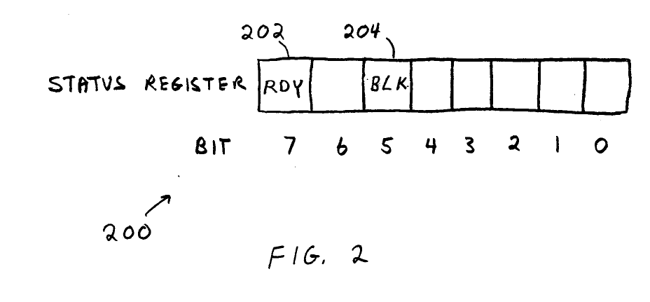

Status register 134 may be a register that includes status information accessible via bus 140. For example, in some embodiments, status register 134 may include information that reflects whether memory device 100 is busy or whether a portion of FLASH memory core 102 is blank. An example embodiment of status register 134 is shown in FIG. 2.

Control block 104 communicates with FLASH memory core 102 and external interface 130 via internal bus 110. Internal bus 110 may take any form. For example, internal bus may be a serial bus, a parallel bus, or a parallel bus with time-multiplexed signals. In some embodiments, a portion of internal bus 110 is dedicated to communications between two blocks within memory device 100. For example, in some embodiments, a portion of internal bus 110 may be dedicated to communications between FLASH memory core 102 and control block 104. Also for example, a portion of internal bus 110 may be dedicated between external interface 130 and control block 104. Further, in some embodiments, a portion of internal bus 110 may be dedicated to communications between external interface 130 and FLASH memory block 102.

Control block 104 may include sequential elements that allow control block 104 to execute commands. For example, in some embodiments, control block 104 may be a state machine. Also for example, in some embodiments, control block 104 may be a microcontroller. In operation, control block 104 performs varying operations within memory device 100. For example, in some embodiments, control block 104 receives commands that have been issued to command interface 132 from an external source via bus 140.

For simplicity, memory device 100 is shown with one FLASH memory core, one control block and one external interface. In some embodiments, memory device 100 may have multiple FLASH memory cores, multiple control blocks, multiple external interfaces, or any combination. The methods and apparatus of the present invention may be applied to all memory cores within a memory device, or to less than all memory cores within a memory device.

In some embodiments, control block 104 may receive an indication that command interface 132 has received a “blank check” command. Control block 104 may check FLASH memory core 102 to verify that it is blank, and write information to status register 134 to indicate that FLASH memory core 102 is blank. In some embodiments, blank check commands specify a block to be blank checked. In these embodiments, control block 104 may check the block that is specified, and indicate whether the specified block is blank by writing information to status register 134.

Control block 104 may read locations within FLASH memory core 102 to verify they are blank. For example, if a block is specified with a blank check command, control block 104 may read the locations that are part of the specified block to verify they are blank.

In some embodiments, a blank check command may include a sequence of commands to be written to command interface 132. For example, a blank check command may include a “blank check setup” command followed by a “blank check confirm” command. Control block 104 may be adapted to report an error if an incorrect sequence is received. For example, if a blank check setup command is not followed by a blank check confirm command, control block 104 may report an error that is accessible by an external device. Errors may be reported through registers in external interface 130, but the invention is not limited in this respect.

FIG. 2 shows a block diagram of a status register. Status register 200 is shown in FIG. 2 as an eight bit register, but the invention is not limited in this respect. For example, some embodiments include status registers of less than eight bits, and some embodiments include status registers of more than eight bits. Further, some embodiments include multiple status registers of varying width.

Status register 200 includes a “ready” indication (RDY) at bit location seven, and a “blank” indication (BLK) at bit location five. The RDY bit may indicate that the memory device is busy or ready. Accordingly, the RDY bit may also be referred to as a “busy” bit. For example, when the RDY bit is set, this may indicate that the memory device is ready to be accessed by an external device, and when the RDY bit is cleared, this may indicate that the memory device is busy. The polarity of the RDY bit is not a limitation of the present invention. For example, a busy indication may be provided when the RDY bit is set, and a ready indication may be provided when the RDY bit is cleared.

The BLK bit is a status bit that may indicate that the memory device is blank or that a portion of the memory device is blank. For example, the BLK bit may indicate that a single block of FLASH memory core 102 (FIG. 1) is blank or that the entire memory core is blank. In some embodiments, the BLK bit is written to by control block 104 (FIG. 1) when a blank check operation is complete. In embodiments that include a block specification with a blank check command, the BLK bit may indicate that the specified block is blank or not blank. The BLK bit may have any polarity. For example, when the BLK bit is set, this may indicate that the specified portion of the memory is blank, and when the BLK is cleared, this may indicate that the specified portion of the memory is not blank. Also for example, when the BLK bit is set, this may indicate that the specified portion of the memory is not blank, and when the BLK bit is cleared, this may indicate that the specified portion of the memory is blank.

In embodiments that include one or more status registers, RDY bits and BLK bits can occupy any part of the status registers. Bit locations seven and five are shown in FIG. 2 for illustration only, and are not meant to be a limitation of the present invention.

Memory devices, control blocks, external interfaces, status registers, and other embodiments of the present invention can be implemented in many ways. In some embodiments, they are implemented in integrated circuits. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, status register 200 may be represented as polygons assigned to layers of an integrated circuit.

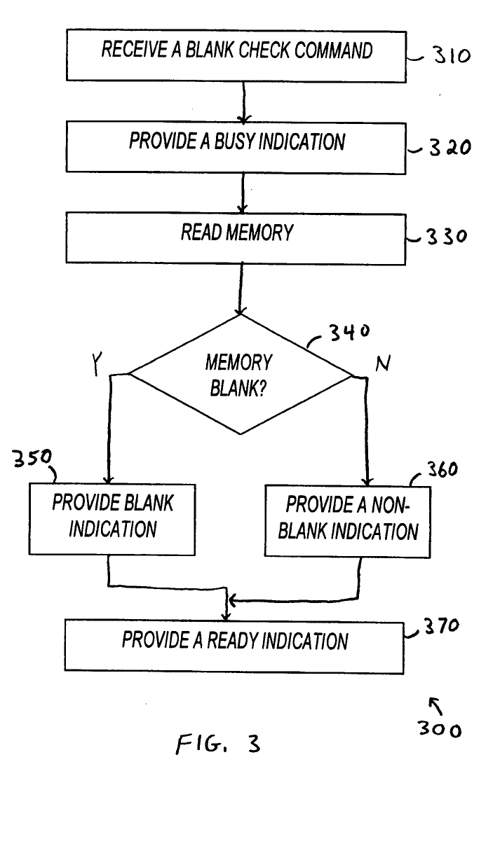

FIG. 3 shows a flowchart in accordance with various embodiments of the present invention. In some embodiments, method 300, or portions thereof, is performed by a memory device or a control block within a memory device, embodiments of which are described with reference to the various figures. In some embodiments method 300 is performed in software by a microcontroller within a memory device. Method 300 is not limited by the particular type of apparatus or software element performing the method. The various actions in method 300 may be performed in the order presented, or may be performed in a different order. Further, in some embodiments, some actions listed in FIG. 3 are omitted from method 300.

Method 300 is shown beginning with block 310 in which a blank check command is received. A blank check command may be received at a command interface of a memory device such as command interface 132 (FIG. 1). In some embodiments, the blank check command may be a multi-part command. For example, the blank check command may include a blank check setup command and a blank check confirm command. The blank check command may also specify a block of memory to check. The block of memory to check may be a portion of the memory device, the entire memory device, or a portion of a block of a memory device. The size or orientation of memory to be checked is not a limitation of the present invention.

At 320, a busy indication is provided. In some embodiments, the busy indication may be provided by setting or clearing a bit in a status register. For example, referring now to FIG. 2, a busy indication may be provided by clearing RDY bit 202. In other embodiments, a busy indication may be provided by an indicator other than a bit in a status register. For example, a memory device may respond to a command that requests status. The memory device may respond to the status request with a busy indication. Further, a busy indication may be provided by a signal level on a pin of the memory device.

At 330, memory is read, and at 340, the memory is checked to verify it is blank. If it is not blank, a non-blank indication is provided at 360, and if it is blank, a blank indication is provided at 350. In some embodiments, the blank indication may be provided by setting or clearing a bit in a status register. For example, referring now to FIG. 2, a blank indication may be provided by setting BLK bit 204. In other embodiments, a blank or non-blank indication may be provided by an indicator other than a bit in a status register. For example, a memory device may respond to a command that requests status. The memory device may respond to the status request with a blank or non-blank indication. Further, a blank or non-blank indication may be provided by a signal level on a pin of the memory device.

At 370, a ready indication is provided to signify that the BLK bit is valid. In some embodiments, the ready indication is the opposite of the busy indication provided at 320. For example, when the busy indication is provided by setting a bit in a status register, the ready indication may be provided by clearing the bit in the status register. In other embodiments, the ready indication is provided by a bit in a status register that is separate from the bit that provides the busy indication. In other embodiments, a ready indication may be provided by an indicator other than a bit in a status register. For example, a memory device may respond to a command that requests status. The memory device may respond to the status request with a ready indication. Further, a ready indication may be provided by a signal level on a pin of the memory device.

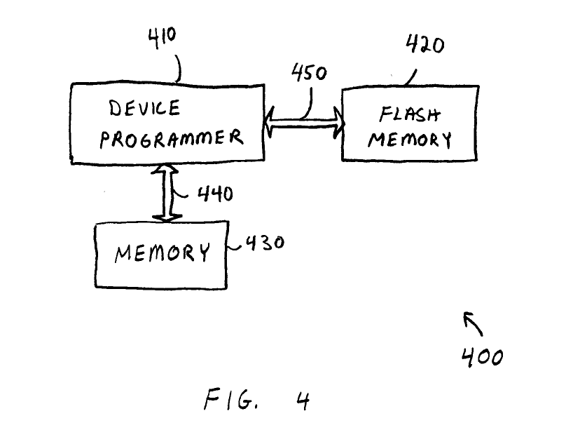

FIG. 4 shows a system diagram in accordance with various embodiments of the present invention. Electronic system 400 includes device programmer 410, FLASH memory 420, and memory 430. Device programmer 410 may be any type of device capable of issuing commands to program all or a portion of FLASH memory 420. For example, device programmer 410 may be a commercially available FLASH memory programmer for programming FLASH memories in a manufacturing environment, or device programmer 410 may a be custom designed programmer to program FLASH memory 420.

FLASH memory 420 may be any FLASH memory adapted to receive a blank check command and provide a blank indication. For example, FLASH memory 420 may be implemented as memory device 100 (FIG. 1). Further, FLASH memory 420 may include a controller, state machine, or other sequential circuit adapted to perform a method for blank check such as method 300 (FIG. 3).

Memory 430 represents an article that includes a machine readable medium. For example, memory 430 represents any one or more of the following: a hard disk, a floppy disk, random access memory (RAM), read only memory (ROM), FLASH memory, CDROM, or any other type of article that includes a medium readable by device programmer 410. Memory 430 can store instructions for performing the execution of the various method embodiments of the present invention.

In operation, device programmer 410 reads instructions and data from memory 430 via bus 440 and performs actions in response thereto. For example, device programmer 410 may issue a blank check command to FLASH memory 420, and read a status register in FLASH memory 420 to verify that the memory is blank. Also for example, device programmer 410 may access instructions from memory 430 and check a status register in FLASH memory 420 to determine if the memory is busy. Also for example, device programmer 410 may read instructions from memory 430 and program FLASH memory 420. Device programmer 410 is shown coupled to FLASH memory 420 by bus 450. In some embodiments, busses 440 and 450 are combined, so that device programmer 410 uses the same bus, or a portion of the same bus, to access memory 430 and FLASH memory 420.

Although device programmer 410 and memory 430 are shown separate in FIG. 4, embodiments exist that combine the circuitry of device programmer 410 and memory 430 in a single integrated circuit. For example, memory 430 may be a hard disk within device programmer 410 or may be a microprogram control store accessible by a processor within device programmer 410.

The type of interconnection between device programmer 410 and FLASH memory 420 is not a limitation of the present invention. For example, bus 450 may be a serial interface, a test interface, a parallel interface, or any other type of interface capable of transferring command and status information between device programmer 410 and FLASH memory 420.

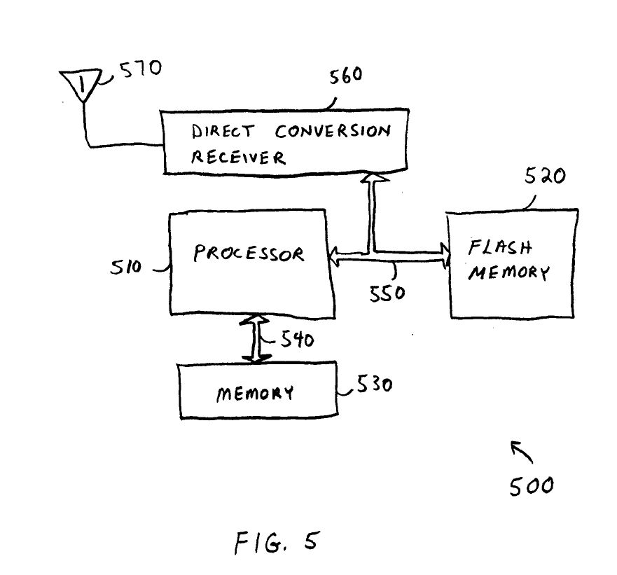

FIG. 5 shows a system diagram in accordance with various embodiments of the present invention. Electronic system 500 includes processor 510, memory 530, FLASH memory 520, direct conversion receiver 560, and antenna 570. Processor 510 may be any type of processor adapted to issue blank check commands to FLASH memory 520. For example, processor 510 may be a microprocessor, a digital signal processor, a microcontroller, or the like.

In systems represented by FIG. 5, processor 510 is coupled to direct conversion receiver 560 and FLASH memory 520 by bus 550. Direct conversion receiver 560 receives communications signals from antenna 570 and also communicates with processor 510 on bus 550. In some embodiments, direct conversion receiver 560 provides communications data to processor 510. Also in some embodiments, processor 510 provides control information to direct conversion receiver 560 on bus 550.

FLASH memory 520 may be any FLASH memory adapted to receive a blank check command and provide a blank indication. For example, FLASH memory 520 may be implemented as memory device 100 (FIG. 1). Further, FLASH memory 520 may include a controller, state machine, or other sequential circuit adapted to perform a method for blank check such as method 300 (FIG. 3).

Direct conversion receiver 560 may “down-convert” signals received from antenna 570 directly to baseband. Because direct conversion receiver 560 does not utilize an intermediate frequency (IF), it may also be referred to as a “zero-IF” receiver.

In some embodiments, system 500 includes a transceiver that both transmits and receives signals at antenna 570. For example, system 500 may be a cell phone with a transmitter and a receiver. Also for example, system 500 may be a wireless local area network interface that includes both a transmitter and a receiver.

Example systems represented by FIG. 5 include cellular phones, personal digital assistants, wireless local area network interfaces, and the like. FLASH memory 520 may be adapted to hold information for system 500. For example, FLASH memory may hold device configuration data, such as contact information with phone numbers, or settings for direct conversion receiver 560. Many other systems uses for FLASH memory 520 exist. For example, FLASH memory 520 may be used in a desktop computer, a network bridge or router, or any other system without a direct conversion receiver. Also for example, FLASH memory 520 may be used in a system that includes a heterodyne receiver that utilizes an intermediate frequency.

Direct conversion receiver 560 may be adapted to receive and demodulate signals of various formats and at various frequencies. For example, direct conversion receiver 560 may be adapted to receive time domain multiple access (TDMA) signals, code domain multiple access (CDMA) signals, GSM signals, or any other type of communications signals. The present invention is not limited in this regard. For ease of illustration, frequency conversion and other signal processing is not shown in FIG. 5.

Memory 530 represents an article that includes a machine readable medium. For example, memory 530 represents any one or more of the following: a hard disk, a floppy disk, random access memory (RAM), read only memory (ROM), FLASH memory, CDROM, or any other type of article that includes a medium readable by processor 510. Memory 530 can store instructions for performing the execution of the various method embodiments of the present invention.

In operation, processor 510 reads instructions and data from memory 530 via bus 540 and performs actions in response thereto. For example, processor 510 may issue a blank check command to FLASH memory 520, and read a status register in FLASH memory 520 to verify that the memory is blank. Also for example, processor 510 may access instructions from memory 530 and check a status register in FLASH memory 520 to determine if FLASH memory 520 is busy. Also for example, processor 510 may read instructions from memory 530 and program FLASH memory 520. Processor 510 is shown coupled to FLASH memory 520 by bus 550. In some embodiments, busses 540 and 550 are combined, so that processor 510 uses the same bus, or a portion of the same bus, to access memory 530 and FLASH memory 520.

Although processor 510 and memory 530 are shown separate in FIG. 5, embodiments exist that combine the circuitry of processor 510 and memory 530 in a single integrated circuit. For example, memory 530 may be an internal memory within processor 510 or may be a microprogram control store within processor 510.

The type of interconnection between processor 510 and FLASH memory 520 is not a limitation of the present invention. For example, bus 550 may be a serial interface, a test interface, a parallel interface, or any other type of interface capable of transferring command and status information between processor 510 and FLASH memory 520.

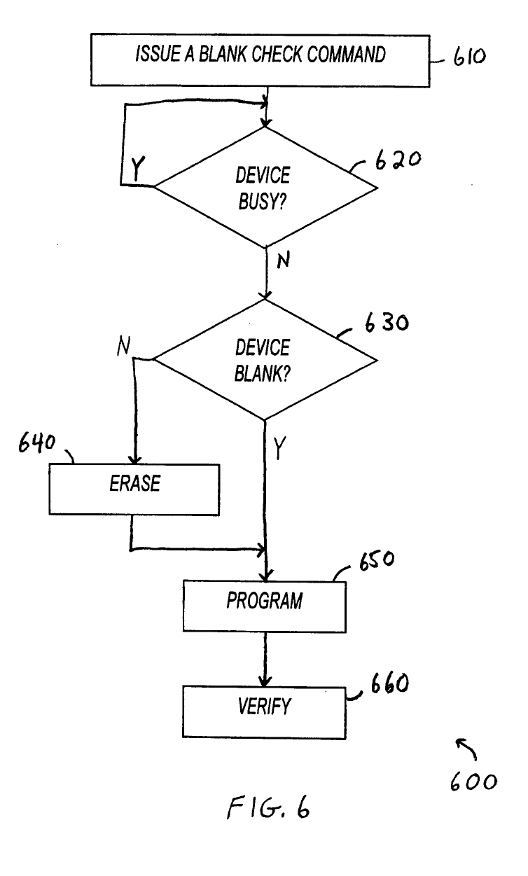

FIG. 6 shows a flowchart in accordance with various embodiments of the present invention. In some embodiments, method 600, or portions thereof, is performed by a device external to a memory device or by an electronic system that includes a memory device. For example, method 600 may be performed by a device programmer or by a processor in an electronic system such as a cellular phone or a wireless network interface. Also for example, in some embodiments method 600 is performed by a dedicated controller that communicates with a memory device. Method 600 is not limited by the particular type of apparatus or software element performing the method. The various actions in method 600 may be performed in the order presented, or may be performed in a different order. Further, in some embodiments, some actions listed in FIG. 6 are omitted from method 600.

Method 600 is shown beginning with block 610 in which a blank check command is issued. In some embodiments, the blank check command is issued by writing a command to a memory device. For example, device programmer 410 (FIG. 4) or processor 510 (FIG. 5) may issue a blank check command by writing to a command interface in FLASH memory 420 or 520. In some embodiments, the blank check command may be a multi-part command. For example, the blank check command may include a blank check setup command and a blank check confirm command. The blank check command may also specify a block of memory to check. The block of memory to check may be a portion of the memory device, the entire memory device, or a portion of a block of a memory device. The size or orientation of memory to be checked is not a limitation of the present invention.

At 620, the memory device is checked to see if it is busy. In some embodiments, the actions of 620 include checking a busy indication in a status register of the memory device. For example, referring now to FIG. 2, a busy indication may be received by method 600 by reading RDY bit 202 of status register 200. In other embodiments, a busy indication may be checked by responding to an indicator other than a bit in a status register. For example, a command that requests status may be issued to the memory device, and the memory device may respond to the status request with a busy indication. Further, a busy indication may be received by a signal level on a conductor coupled to the memory device.

When the device is no longer busy, at 630, a blank indicator is checked to see if the memory is blank. In some embodiments, the blank indication may be checked by reading a bit in a status register of the memory device. For example, referring now to FIG. 2, a blank indication may be checked by reading the BLK bit 204 of status register 200. In other embodiments, a blank or non-blank indication may be checked by responding to an indicator other than a bit in a status register. For example, a command that requests status may be issued to the memory device, and the memory device may respond to the status request with a blank or non-blank indication. Further, a blank or non-blank indication may be received by a signal level on a conductor coupled to the memory device.

In some embodiments, the blank indication indicates that a portion of the memory is blank. For example, in some embodiments, a blank check command that includes a block specification may be issued. In these embodiments, the blank indication may indicate whether the specified block is blank or not.

In some embodiments, a portion of method 600 or all of method 600 may be repeated for multiple blocks within a memory device. For example, a subset of the total number of blocks in a memory device may be blank checked using repetitions of a portion of method 600. Also for example, each block within a memory device may be blank checked using repetitions of a portion of method 600.

If the device is not blank, the device is erased at 640, and the device is programmed at 650 and verified at 660.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
issuing a blank check command to a memory device; and
reading a status bit in the memory device to verify that at least a portion of the memory device is blank.

2. The method of claim 1 further comprising checking a busy bit in the memory device adapted to signify that the status bit is valid.

3. The method of claim 1 wherein issuing a blank check command comprises:
issuing a blank check setup command; and
issuing a blank check confirm command.

4. The method of claim 1 further comprising specifying a block to blank check.

5. The method of claim 4 further comprising repeating the listed actions for more than one block in the memory device.

6. The method of claim 4 further comprising repeating the listed actions for each block in the memory device.

7. A method comprising:
receiving a blank check command;
reading a plurality of memory locations in at least one block of a memory device; and
writing to a bit in a status register.

8. The method of claim 7 wherein receiving a blank check command comprises:
receiving a blank check setup command; and
receiving a blank check confirm command.

9. The method of claim 7 wherein reading a plurality of memory locations comprises reading each memory location in the at least one block.

10. The method of claim 7 further comprising:
setting a busy bit adapted to signify the memory device is busy; and
clearing the busy bit after writing to the bit in the status register.

11. The method of claim 7 wherein receiving a blank check command comprises receiving an indication of a block to blank check.

12. The method of claim 11 wherein reading a plurality of memory locations comprises reading memory locations in the indicated block.

13. A memory device comprising:
a FLASH memory core; and
a control block adapted to blank check at least a portion of the FLASH memory core.

14. The memory device of claim 13 further comprising a status register adapted to signify that the at least a portion of the FLASH memory core is blank.

15. The memory device of claim 13 wherein the control block comprises a state machine.

16. The memory device of claim 13 wherein the control block comprises a microcontroller.

17. The memory device of claim 13 further comprising an external interface including a command register.

18. The memory device of claim 17 wherein the external interface further includes a status register.

19. An apparatus including a medium adapted to hold machine-accessible instructions that when accessed result in a machine performing:
issuing a blank check command to a memory device; and
reading a status bit in the memory device to verify that at least a portion of the memory device is blank.

20. The apparatus of claim 19 wherein the instructions, when accessed, further result in the machine performing:
checking a busy bit prior to reading the status bit.

21. The apparatus of claim 19 wherein issuing a blank check command comprises:
issuing a blank check setup command; and
issuing a blank check confirm command.

22. The apparatus of claim 19 wherein the instructions, when accessed, further result in the machine performing:
issuing blank check commands and reading the status bit for more than one block in the memory device.

23. An electronic system comprising:
a direct conversion receiver;
a memory device including a FLASH memory core and a control block adapted to blank check at least a portion of the memory core; and
a processor coupled to the direct conversion receiver and the memory device.

24. The electronic system of claim 23 wherein the control block comprises a microcontroller.

25. The electronic system of claim 23 wherein the memory device further includes an external interface including a status register adapted to indicate whether the at least a portion of the memory device is blank.

26. An electronic system comprising:
a direct conversion receiver;
a FLASH memory device;
a processor coupled to the direct conversion receiver and the FLASH memory device; and
an article having a machine accessible medium holding instruction that when accessed result in the processor issuing a blank check command to the FLASH memory device and reading a status bit in the FLASH memory device.

27. The electronic system of claim 26 wherein issuing a blank check command comprises:
issuing a blank check setup command; and
issuing a blank check confirm command.

28. The electronic system of claim 26 wherein the instructions, when accessed, further result in the machine performing:
issuing blank check commands and reading the status bit for more than one block in the memory device.
